(19) United States
(12) Patent Application Publication
(10) Pub. No.: US 2010/0184883 A1
(43) Pub. Date: Jul. 22, 2010

(54) Extenders For Organosiloxane Compositions

(76) Inventors: Tommy Detemmerman, Wezembeek-oppem (BE); Robert Andrew Drake, Penarth (GB); Andrew Michael Donlan, Penarth (GB); Jary David Jensen, Beaverton, MI (US); Leslie Patterson, Kraainem (BE); Jean Willieme, Quaregnon (BE)

Correspondence Address: HOWARD & HOWARD ATTORNEYS PLLC, 450 West Fourth Street, Royal Oak, MI, 48067, US

(21) Appl. No.: 12/445,097

(22) PCT Filed: Oct. 9, 2007
(86) PCT No.: PCT/US07/21545

§ 371 Date: Mar. 9, 2010

Related U.S. Application Data
(60) Provisional application No. 60/828,831, filed on Oct. 10, 2006.

(51) Int. Cl. C09D 183/04; B05D 3/02

(52) U.S. Cl. 523/122; 427/387; 524/300; 524/315; 524/413; 524/423; 524/424; 524/425; 524/431; 524/436; 524/444; 524/445; 524/448; 524/451; 524/456; 524/588

(57) ABSTRACT

An organopolysiloxane composition capable of cure to an elastomeric body, the composition Comprising an organopolysiloxane containing polymer having not less than two reactable silicon-bonded groups selected from alkenyl group, condensable groups, silyl-hydride groups and/or one or more trialkylsilyl containing terminal groups, optionally a siloxane and/or silane cross-linker having at least two groups per molecule which are reactable with the reactable groups in (a); 5 to 50% by weight of the composition of at least one compatible natural oil and/or natural oil derivative based extender and/or plasticiser; a suitable cure catalyst and optionally one or more fillers. The compositions are particularly useful as sealants.

This invention is concerned with the use of extenders in organosiloxane based compositions and other silicon containing polymeric materials including those useful as sealing materials and elastomers.

Organosiloxane compositions which cure to elastomeric solids are well known and such compositions can be produced to cure at either room temperature in the presence of moisture or with application of heat. Typically those compositions which cure at room temperature in the presence of moisture are obtained by mixing a polydiorganosiloxane based polymer having reactive terminal groups, with a suitable silane (or siloxane) based cross-linking agent in the presence of one or more fillers and a curing catalyst. These compositions are typically either prepared in the form of one-part compositions curable upon exposure to atmospheric moisture at room temperature or two part compositions curable upon mixing at room temperature and pressure.

One important application of the above-described room temperature curable compositions is their use as sealants. In use as a sealant, it is important that the composition has a blend of properties which render it capable of being applied as a paste to a joint between substrate surfaces where it can be worked, prior to curing, to provide a smooth surfaced mass which will remain in its allotted position until it has cured into an elastomeric body adherent to the adjacent substrate surfaces. Typically sealant compositions are designed to cure quickly enough to provide a sound seal within several hours but at a speed enabling the applied material to be tooled into a desired configuration shortly after application. The resulting cured sealant is generally formulated to have a strength and elasticity appropriate for the particular joint concerned.

It has become common practice in the formulation of silicone based compositions used as room temperature cure sealants, to include additives which serve to “extend” and/or “plasticise” the silicone sealant composition by blending the or each extending compound (henceforth referred to as an “extender”) and/or plasticising compound (henceforth referred to as a “plasticiser”) with a pre-prepared polymer and other ingredients of the composition.

An extender (sometimes also referred to as a process aid or secondary plasticiser) is used to dilute the sealant composition and basically make the sealant more economically competitive without substantially negatively affecting the properties of the sealant formulation. The introduction of one or more extenders into a silicone sealant composition not only reduces the overall cost of the product but can also affect the properties of resulting uncured and/or cured silicone sealants. The addition of extenders can, to a degree, positively effect the rheology, adhesion and tooling properties and clarity of a silicone sealant and can cause an increase in elongation at break and a reduction in hardness of the cured product both of which can significantly enhance the lifetime of the cured sealant provided the extender is not lost from the cured sealant by, for example, evaporation or exudation.

A plasticiser (otherwise referred to as a primary plasticiser) is added to a polymer composition to provide properties within the final polymer based product to increase the flexibility and toughness of the final polymer composition. This is generally achieved by reduction of the glass transition temperature (T_{g}) of the cured polymer composition thereby generally, in the case of sealants for example, enhancing the elasticity of the sealant which in turn enables movement capabilities in a joint formed by a silicone sealant with a significant decrease in the likelihood of fracture of the bond formed between sealant and substrate when a sealant is applied thereto and cured. Plasticisers are typically used to also reduce the modulus of the sealant formulation. Plasticisers may reduce the overall unit cost of a sealant but that is not their main intended use and indeed some plasticisers are expensive and could increase the unit cost of a sealant formulation in which they are used. Plasticisers tend to be generally less volatile than extenders and are typically introduced into the polymer composition in the form of liquids or low melting point solids (which become miscible liquids during processing.

Typically, for silicone based compositions plasticisers are organopolysiloxanes which are unreactive with the siloxane polymer of the composition, such as polydimethylsiloxane having terminal triorganosiloxy groups wherein the organic substituents are, for example, methyl, vinyl or phenyl or combinations of these groups. Such polydimethylsiloxanes normally have a viscosity of from about 5 to about 100,000 mPa·s at 25° C. Compatible organic plasticisers may additionally be used, examples include dialkyl phthalates wherein the alkyl group may be linear and/or branched and contains from six to 20 carbon atoms such as dioctyl, dihexyl, dinonyl, didecyl, diallanyl and other phthalates; adipate, azelate, oleate and sebacate esters, polyols such as ethylene glycol and its derivatives, organic phosphates such as tricresyl phosphate and/or triphenyl phosphates.

Typically plasticisers are more compatible with polymer compositions than extenders and tend to be significantly less volatile and as such are significantly more likely to remain at high levels within the polymer matrix after curing.

Extenders need to be both sufficiently compatible with the remainder of the composition and as non-volatile as possible at the temperature at which the resulting cured elastomeric solid is to be maintained (e.g. room temperature). However it has been found that whilst some proposed extenders are effective during storage, at the time of application of the sealant and at least for a time thereafter, there are several well known problems regarding their use. These include:
(i) Poor compatibility with the polymer composition (e.g. a sealant composition) leading to their exuding from the sealant over time which negatively effects the physical and aesthetic properties and lifetime of the cured product e.g. sealant; and
(ii) Staining of the surrounding substrates onto which the extenders exude from the composition.

Compatibility of organic extenders and/or plasticisers with the other ingredients in an organopolysiloxane based polymer composition, is a significantly greater problem than with respect to organic based polymers, silicone polymers into which the extenders and/or plasticisers are introduced tend to be highly viscous polymers, and the chemical nature of the polymer being organopolysiloxane based as opposed to organic based can have significant effects on compatibility. The level of compatibility effectively determines the amount of extender and/or plasticiser which can be introduced into a polymer composition. Typically this results in the introduction of significantly lower amounts of, in particular, extenders into the composition than may be desired because the extender will not physically mix into the polymer composition sufficiently well, particularly with the pre-formed polymer which is usually the largest component, other than the filler, in the composition.

A wide variety of organic compounds and compositions have been proposed for use as extenders for reducing the cost of the silicone sealant compositions. Whilst polyalkylbenzenes such as heavy alkylates (alkylated aromatic materials remaining after distillation of oil in a refinery) have been proposed as extender materials for silicone sealant compositions in recent years, the industry has increasingly used mineral oil based (typically petroleum based) paraffinic hydrocarbons as extenders as described in the applicant's prior application No GB 2424898 which was published after the priority date of this application and the following publications: EP0885921 describes the use of mineral oil based hydrocarbon mixtures containing 60 to 80% paraffinic and 20 to 40% naphthenic and a maximum of 1% aromatic carbon atoms. EP 0807667 appears to describe a similar extender comprising wholly or partially of a paraffin oil comprising 36-40% cyclic paraffin oils and 58 to 64% non-cyclic paraffin oils. WO99/65979 describes an oil resistant sealant composition comprising a 2 5 plasticiser which may include paraffinic or naphthenic oils and mixtures thereof amongst other plasticisers. EP1481038 describes the use of a hydrocarbon fluid containing more than 60 wt. % naphthenics, at least 20 wt. % polycyclic naphthenics and an ASTM D-86 boiling point of from 235° C. to 400° C. EP1252252 describes the use of an extender comprising a hydrocarbon fluid having greater than 40 parts by weight cyclic paraffinic hydrocarbons and less than 60 parts by weight monocyclic paraffinic hydrocarbons based on 100 parts by weight of hydrocarbons. EP1368426 describes a sealant composition for use with alkyd paints containing a liquid paraffinic hydrocarbon “extender” which preferably contains greater than 40% by weight of cyclic paraffins.

A variety of other extenders are described in the literature. These include synthetically prepared Fischer-Tropsch derived oils as described in WO2004/009738 and the use of animal and/or vegetable oils in adhesion sheets for keratinic plug removal from the nose or jaw as described in JP10-101527. HU201572 (B) describes the introduction of from 0.5-3% by weight of a vegetable oil (castor oil) in a pigmented sealant composition consisting of 30 to 55% by weight of a dihydroxypolydimethylsiloxane having a viscosity of 10 000 to 80 000 mPa·s, 5-18% silicone oil plasticiser. The vegetable oil plasticiser, preferably castor oil, was introduced to aid the dispersion of the pigment because there was limited wetting of the pigment by the silicone oil plasticised sealant composition.

It will be appreciated by the reader that there is a degree of overlap between plasticisers and extenders used for silicone polymer based compositions. This is at least partially due to the relative decrease in compatibility of the organic compounds concerned with the silicone compositions.

One of the most important problems the industry is having to deal with is an ever increasing amount of environmental and/or safety legislation necessitating the reduction in volatile content of chemical compositions which effectively prevents utilisation of many of the extenders and/or plasticisers previously proposed in the patent literature.

The applicants have now identified that a wide variety of non-mineral oil based natural oils and derivatives thereof may be used as organic extenders for siloxane formulations.

In accordance with the present invention there is provided a one or two part organopolysiloxane composition capable of cure to an elastomeric body, the composition comprising
a) An organopolysiloxane containing polymer having not less than two reactable silicon-bonded groups selected from alkenyl group, condensable groups, silyl-hydride groups and/or one or more trialkylsilyl containing terminal groups
b) If required, a siloxane and/or silane cross-linker having at least two groups per molecule which are reactable with the reactable groups in (a);
c) 5 to 50% by weight of the composition of at least one compatible natural oil and/or natural oil derivative based extender and/or plasticiser;
d) a suitable cure catalyst; and optionally
e) one or more fillers.

The concept of “comprising” where used herein is used in its widest sense to mean and to encompass the notions of “include” and “consist of”. Preferably the at least one compatible natural oil and/or natural oil derivative based extender and/or plasticiser is/are the only extender and/or plasticiser in the composition.

The condensable groups referred to in (a) are groups, preferably end groups, that will, in appropriate conditions, undergo a condensation reaction. Preferably the condensable groups in the present invention are hydroxyl containing terminal groups or hydrolysable end groups, in which case the composition in accordance with the present invention may be a one or two part organopolysiloxane sealant composition. In the case of a two part composition the composition is retained in two parts until immediately before use. Such a two part composition preferably comprises in the first part polymer (a) and filler (e) (when required) and in the second part catalyst (d) and cross-linker (b) are provided for mixing in an appropriate ratio (e.g. from 10:1 to 1:1) immediately prior to use. Additional additives to be discussed below may be provided in either the first or second part of the two part composition.

In one embodiment of the present invention the polymer component (a) used in the present invention is a polysiloxane containing polymer containing at least two condensable groups, most preferably the condensable groups are terminal hydroxyl or hydrolysable groups. Preferably the polymer has the general formula

X¹-A-X² (1)

where X¹ and X² are independently selected from silicon containing groups which contain hydroxyl or hydrolysable substituents and A is selected from a siloxane containing polymeric or copolymeric molecular chain or a siloxane/organic block copolymeric molecular chain.
Examples of X¹ or X² groups incorporating hydroxyl and/or hydrolysable substituents include groups terminating as described below:
—Si(OH)₃, —(R^{a})Si(OH)₂, —(R^{a})₂SiOH, —R^{a}Si(OR^{b})₂, —Si(OR^{b})₃, —R^{a}₂SiOR^{b} or
—R^{a}₂Si—R^{c}—SiR^{d}ₚ(ORN^{b})₃₋ₚ where each R^{a} independently represents a monovalent hydrocarbyl group, for example, an alkyl group, in particular having from 1 to 8 carbon atoms, (and is preferably methyl); each R^{b} and R^{d} group is independently an alkyl or alkoxy group in which the alkyl groups suitably have up to 6 carbon atoms; R^{c} is a divalent hydrocarbon group which may be interrupted by one or more siloxane spacers having up to six silicon atoms; and p has the value 0, 1 or 2.

Alternatively X¹ and X² may both comprise a group which will undergo an addition type reaction with a suitable cross-linking molecule. Preferably the addition type reaction is a hydrosilylation reaction and X² and X¹ both contain either a silicon-hydrogen bond or unsaturated organic substituents containing from 2 to 6 carbon atoms such as alkenyl groups, alkynyl groups, acrylate groups and/or alkylacrylate groups. However, alkenyl groups are preferred. Representative, non-limiting examples of the alkenyl groups are shown by the following structures; H₂C═CH—, H₂C═CHCH₂—, H₂C═C(CH₃)CH₂—, H₂C═CHCH₂CH₂—, H₂C═CHCH₂CH₂CH₂—, and H₂C═CHCH₂CH₂CH₂CH₂—. Representative, non-limiting examples of alkynyl groups are shown by the following structures; HCE≡C—, HC≡CCH₂—, HC≡CC(CH₃)—, HC≡CC(CH₃)₂—, HC≡CC(CH₃)₂CH₂—.

Most preferably in this embodiment X¹ and X² are both alkenyl containing groups with vinyl containing groups being particularly preferred. A small proportion (<20%) of X¹ groups may comprise trialkylsilyl groups, in which each alkyl group is preferably methyl or ethyl.

Examples of suitable siloxane groups A in formula (I) are those which comprise a polydiorganosiloxane chain. Thus group A preferably includes siloxane units of formula (2)

—(R⁵ₛSiO_{(4-s)/2})— (2)

in which each R⁵ is independently an organic group such as a hydrocarbon group having from 1 to 18 carbon atoms, a substituted hydrocarbon group having from 1 to 18 carbon atoms or a hydrocarbonoxy group having up to 18 carbon atoms and s has, on average, a value of from 1 to 3, preferably 1.8 to 2.2.

For the purpose of this application “Substituted” in the case of hydrocarbon groups means one or more hydrogen atoms in a hydrocarbon group has been replaced with another substituent. Examples of such substituents include, but are not limited to, halogen atoms such as chlorine, fluorine, bromine, and iodine; halogen atom containing groups such as chloromethyl, perfluorobutyl, trifluoroethyl, and nonafluorohexyl; oxygen atoms; oxygen atom containing groups such as (meth)acrylic and carboxyl; nitrogen atoms; nitrogen atom containing groups such as amino-functional groups, amido-functional groups, and cyano-functional groups; sulphur atoms; and sulphur atom containing groups such as mercapto groups. Furthermore, henceforth all viscosities are measured at 25° C. unless otherwise indicated.

Preferably R⁵ is a hydrocarbyl group having from 1 to 10 carbon atoms optionally substituted with one or more halogen group such as chlorine or fluorine and s is 0, 1 or 2. Particular examples of groups R⁵ include methyl, ethyl, propyl, butyl, vinyl, cyclohexyl, phenyl, tolyl group, a propyl group substituted with chlorine or fluorine such as 3,3,3-trifluoropropyl, chlorophenyl, beta-(perfluorobutyl)ethyl or chlorocyclohexyl group. Suitably, at least some and preferably substantially all of the groups R⁵ are methyl.

Group A in the compound of formula (1) may include any suitable siloxane or siloxane/organic molecular chain providing the resulting polymer a viscosity (in the absence of diluents in accordance with the present invention of up to 20 000 000 mPa·s, at 25° C. (i.e. up to or even more than 200 000 units of formula (2)).

The polydiorganosiloxanes comprising units of the structure in structure (2) may be homopolymers or copolymers. Mixtures of different polydiorganosiloxanes are also suitable.

In the case of polydiorganosiloxane co-polymers the polymeric chain may comprise a combination of blocks made from chains of units depicted in FIG. (2) above where the two R⁵ groups are:
both alkyl groups (preferably both methyl or ethyl), or
alkyl and phenyl groups, or
alkyl and fluoropropyl, or
alkyl and vinyl or
alkyl and hydrogen groups.
   Typically at least one block will comprise siloxane units in which both R⁵ groups are alkyl groups.

In one preferred embodiment A is a linear organopolysiloxane molecular chain (i.e. s=2) for all chain units. Preferred materials have polydiorganosiloxane chains comprising units according to the general formula (3)

—(R⁵₂SiO)ₜ— (3)

in which each R⁵ is as defined above and is preferably a methyl group and t has a value of up to at least 200 000. Suitable polymers have viscosities of up to 20 000 000 mPa·s at 25° C.

Whilst preferably A (in formula 1) is an organopolysiloxane molecular chain, A may alternatively be a block copolymeric backbone comprising at least one block of siloxane groups of the type depicted in formula (2) above and an organic component comprising any suitable organic based polymer backbone for example the organic polymer backbone may comprise, for example, polystyrene and/or substituted polystyrenes such as poly(α-methylstyrene), poly(vinylmethylstyrene), dienes, poly(p-trimethylsilylstyrene) and poly(p-trimethylsilyl-α-methylstyrene). Other organic components which may be incorporated in the polymeric backbone may include acetylene terminated oligophenylenes, vinylbenzyl terminated aromatic polysulphones oligomers, aromatic polyesters, aromatic polyester based monomers, polyalkylenes, polyurethanes, aliphatic polyesters, aliphatic polyamides and aromatic polyamides and the like.

However perhaps the most preferred organic based polymeric blocks in A are polyoxyalkylene based blocks, which typically bond with siloxanes via a hydrosilylation reaction prior to introduction of the chain extender of the present invention. Such polyoxyalkylene blocks preferably comprise a linear predominantly oxyalkylene polymer comprised of recurring oxyalkylene units, (—CₙH₂ₙ—O—) illustrated by the average formula (—CₙH₂ₙ—O—)_{y} wherein n is an integer from 2 to 4 inclusive and y is an integer of at least four. The number average molecular weight of each polyoxyalkylene polymer block may range from about 300 to about 10,000. Moreover, the oxyalkylene units are not necessarily identical throughout the polyoxyalkylene monomer, but can differ from unit to unit. A polyoxyalkylene block, for example, can be comprised of oxyethylene units, (—C₂H₄—O—); oxypropylene units (—C₃H₆—O—); or oxybutylene units, (—C₄H₈—O—); or mixtures thereof. Preferably the polyoxyalkylene polymeric backbone consists essentially of oxyethylene units and/or oxypropylene units.

Other polyoxyalkylene blocks may include for example: units of the structure

—[—R^{e}—O—(—R^{f}—O—)ₕ-Pn-CR^{g}₂-Pn-O—(—R^{f}—O—)_{q}—R^{e}]—

in which Pn is a 1,4-phenylene group, each R^{e} is the same or different and is a divalent hydrocarbon group having 2 to 8 carbon atoms, each R^{f} is the same or different and, is, an ethylene group propylene group, or isopropylene group each R^{g} is the same or different and is a hydrogen atom or methyl group and each of the subscripts h and q is a positive integer in the range from 3 to 30.

Any suitable cross-linker (b) may be used in the composition in accordance with the present invention, when required. In the case where the reactable groups in organopolysiloxane (a) are condensable groups the cross linker (b) contains at least two and preferably at least 3 silanol groups or silicon bonded hydrolysable groups. In such a case it is preferred for the cross-linker to be a silane or short chain organopolysiloxane (e.g. having a polymer backbone in accordance with formula 3 above where t is from 2 to about 100). The hydrolysable groups in the silane or short chain organopolysiloxane cross-linker may comprise acyloxy groups (for example, acetoxy, octanoyloxy, and benzoyloxy groups); ketoximino groups (for example dimethyl ketoximo, and isobutylketoximino); alkoxy groups (for example methoxy, ethoxy, an propoxy) and alkenyloxy groups (for example isopropenyloxy and 1-ethyl-2-methylvinyloxy).

In the case of siloxane based cross-linkers the molecular structure can be straight chained, branched, or cyclic.

When the reactable groups in (a) are condensable groups and the cross linker (b) is a silane and when the silane has three silicon-bonded hydrolysable groups per molecule, the fourth group is suitably a non-hydrolysable silicon-bonded organic group. These silicon-bonded organic groups are suitably hydrocarbyl groups which are optionally substituted by halogen such as fluorine and chlorine. Examples of such fourth groups include alkyl groups (for example methyl, ethyl, propyl, and butyl); cycloalkyl groups (for example cyclopentyl and cyclohexyl); alkenyl groups (for example vinyl and allyl); aryl groups (for example phenyl, and tolyl); aralkyl groups (for example 2-phenylethyl) and groups obtained by replacing all or part of the hydrogen in the preceding organic groups with halogen. Preferably however, the fourth silicon-bonded organic group is methyl or ethyl.

Silanes and siloxanes which can be used as cross linkers for polymers (a) containing condensable groups include alkyltrialkoxysilanes such as methyltrimethoxysilane (MTM) and methyltriethoxysilane, alkenyltrialkoxy silanes such as vinyltrimethoxysilane and vinyltriethoxysilane, isobutyltrimethoxysilane (iBTM). Other suitable silanes include ethyltrimethoxysilane, vinyltriethoxysilane, phenyltrimethoxysilane, alkoxytrioximosilane, alkenyltrioximosilane, 3,3,3-trifluoropropyltrimethoxysilane, methyltriacetoxysilane, vinyltriacetoxysilane, ethyl triacetoxysilane, di-butoxy diacetoxysilane, phenyl-tripropionoxysilane, methyltris(methylethylketoximo)silane, vinyl-tris-methylethylketoximo)silane, methyltris(methylethylketoximino)silane, methyltris(isopropenoxy)silane, vinyltris(isopropenoxy)silane, ethylpolysilicate, n-propylorthosilicate, ethylorthosilicate, dimethyltetraacetoxydisiloxane. The cross-linker used may also comprise any combination of two or more of the above.

Further alternative cross-linkers include Alkylalkenylbis(N-alkylacetamido)silanes such as methylvinyldi-(N-methylacetamido)silane, and methylvinyldi-(N-ethylacetamido)silane; dialkylbis(N-arylacetamido)silanes such as dimethyldi-(N-methylacetamido)silane; and dimethyldi-(N-ethylacetamido)silane; Alkylalkenylbis(N-arylacetamido)silanes such as methylvinyldi(N-phenylacetamido)silane and dialkylbis(N-arylacetamido)silanes such as dimethyldi-(N-phenylacetamido)silane. The cross-linker used may also comprise any combination of two or more of the above.

The amount of cross linker (b) present in the composition when the reactable groups in (a) are condensable groups will depend upon the particular nature of the cross linker and in particular, the molecular weight of the molecule selected. The compositions suitably contain cross linker in at least a stoichiometric amount as compared to the polymeric material described above. Compositions may contain, for example, from 2-30% w/w of cross linker, but generally from 2 to 10% w/w. Acetoxy cross linkers may typically be present in amounts of from 3 to 8% w/w preferably 4 to 6% w/w whilst oximino cross-linkers, which have generally higher molecular weights will typically comprise from 3-8% w/w.

When the reactable groups in (a) are unsaturated groups which readily undergo addition reactions with Si—H groups the cross-linker (b) in accordance with the composition of the present invention preferably comprises a silane or siloxane comprising at least two Si—H groups. Most preferably in this instance Component (b) is an organohydrogensiloxane having an average of greater than two silicon bonded hydrogen atoms per molecule and a viscosity of up to about 10 Pa·s at 25° C. The organohydrogensiloxane which functions as a cross-linker contains an average of at least two silicon-bonded hydrogen atoms per molecule, and no more than one silicon-bonded hydrogen atom per silicon atom, the remaining valences of the silicon atoms being satisfied by divalent oxygen atoms or by monovalent hydrocarbon radicals comprising one to seven carbon atoms. The monovalent hydrocarbon radicals can be, for examples, alkyls such as methyl, ethyl, propyl, tertiary butyl, and hexyl; cylcoalkyls such as cyclohexyl; and aryls such as phenyl and tolyl. Such materials are well known in the art. The molecular structure of the organohydrogensiloxane may be linear, linear including branching, cyclic, or network-form or mixture thereof. There are no particular restrictions on the molecular weight of the organohydrogensiloxane, however it is preferable that the viscosity at 25° C. be 3 to 10,000 mPa·s. Furthermore, the amount of component (b) that is added to the composition is an amount such that the ratio of the number of moles of hydrogen atoms bonded to silicon atoms to the number of moles of alkenyl groups bonded to silicon atoms is in the range of 0.5:1 to 20:1, and preferably in the range of 1:1 to 5:1. If this molar ratio is less than 0.5, curing of the present composition becomes insufficient, while if this molar ratio exceeds 20 hydrogen gas is evolved so that foaming occurs.

The silicon-bonded organic groups present in the organohydrogensiloxane can include substituted and unsubstituted alkyl groups of 1-4 carbon atoms that are otherwise free of ethylenic or acetylenic unsaturation.

When the reactable groups in (a) are Si—H which readily undergo addition reactions with unsaturated groups the cross-linker (b) comprises a silane or siloxane comprising at least two unsaturated groups. Preferably in this case cross-linker (b) is a short chain siloxane (containing between 2 and 20 silicon atoms) having at least three alkenyl groups. Preferably the alkenyl groups contain between 2 and 10 carbon atoms such as for example vinyl, propenyl, and/or hexenyl groups, vinyl groups being particularly preferred.

Preferably extender and/or plasticiser (c) may comprise a suitable non-mineral based natural oil or a mixture of said suitable non-mineral based natural oils, i.e. those derived from animals, seeds and nuts and not from mineral oils (i.e. not from petroleum or petroleum based oils). Preferably extender and/or plasticiser (c) does not contain an unreactive silicone oil. More preferably the only extender(s) and/or plasticiser(s) (c) present in the composition are a suitable non-mineral based natural oil or a mixture of said suitable non-mineral based natural oils In one preferred embodiment of the present invention extender and/or plasticiser (c) consists of said suitable non-mineral based natural oil or a mixture of said suitable non-mineral based natural oils such as for example almond oil, avocado oil, beef tallow, borrage oil, butterfat, canola oil, cardanol, cashew nut oil, cashew nutshell liquid, castor oil, citrus seed oil, cocoa butter, coconut oil, cod liver oil, corn oil, cottonseed oil, cuphea oil, evening primrose oil, hemp oil, jojoba oil, lard, linseed oil, macadamia oil, menhaden oil, oat oil, olive oil, palm kernel oil, palm oil peanut oil, poppy seed oil, rapeseed oil, rice bran oil, safflower oil, safflower oil (high oleic), sesame oil, soybean oil, sunflower oil, sunflower oil (high oleic), tall oil, tea tree oil, turkey red oil, walnut oil, perilla oil, dehydrated castor oils, apricot oil, pine nut oil, kukui nut oil, amazon nut oil, almond oil, babasu oil, argan oil, black cumin oil, bearberry oil, calophyllum oil, camelina oil, carrot oil, carthamus oil, cucurbita oil, daisy oil, grape seed oil, foraha oil, jojoba oil, queensland oil, onoethera oil, ricinus oil, tamanu oil, tucuma oil, fish oils such as pilchard, sardine and herring oils. The extender may alternatively comprise mixtures of the above non-mineral based natural oils and/or derivatives of one or more of the above.

A wide variety of derivates are available. These include transesterified natural vegetable oils, boiled natural oils such as boiled linseed oil, blown natural oils and stand natural oils. An example of a suitable transesterified natural vegetable oil is known as biodiesel oil, the transesterification product produced by reacting mechanically extracted natural vegetable oils from seeds, such as rape, with methanol in the presence of a sodium hydroxide or potassium hydroxide catalyst to produce a range of esters dependent on the feed utilised. Examples might include for example methyloleate (CH₃(CH₂)₇CH═CH(CH₂)₇CO₂CH₃).

Stand natural oils which are also known as thermally polymerised or heat polymerised oils and are produced at elevated temperatures in the absence of air. The oil polymerises by cross-linking across the double bonds which are naturally present in the oil. The bonds are of the carbon-carbon type. Stand natural oils are pale coloured and low in acidity. They can be produced with a wider range of viscosities than blown oils and are more stable in viscosity. In general, stand natural oils are produced from linseed oil and soya bean oil but can also be manufactured based on other oils. Stand natural oils are widely used in the surface coatings industry.

Blown oils which are also known as oxidised, thickened and oxidatively polymerised oils and are produced at elevated temperatures by blowing air through the oil. Again the oil polymerises by cross-linking across the double bonds but in this case there are oxygen molecules incorporated into the cross-linking bond. Peroxide, hydroperoxide and hydroxyl groups are also present. Blown oils may be produced from a wider range of oils than stand natural oils. In general, blown oils are darker in colour and have a higher acidity when compared to stand natural oils. Because of the wide range of raw materials used, blown oils find uses in many diverse industries, for example blown linseed oils are used in the surface coatings industry and blown rapeseed oils are often used in lubricants.

The amount of extender and/or plasticiser which may be included in the composition in accordance with the present invention will depend upon factors such as the purpose to which the composition is to be put, the molecular weight of the extender(s) concerned etc. In general however, the higher the molecular weight of the extender(s), the less will be tolerated in the composition but such high molecular weight extenders have the added advantage of lower volatility thus enabling the sealant composition to meet ISO 10563 requirements. Typical compositions will contain up to 70% w/w extender(s)/plasticiser(s). More suitable polymer products comprise from 5-50% w/w of extender(s)/plasticiser(s).

The extender/plasticiser in accordance with the present invention may be blended with the other ingredients of the composition in accordance with the present invention as required or may be introduced into the monomer/oligomer mixture prior to or during the polymerisation of polymer component (a).

Generally the extender(s)/plasticiser(s) used in accordance with the present invention are not intended to chemical bond to the monomer/oligomer starting materials or intermediate or final polymerisation product. However, some chemical bonding and/or reversible interactions between the polymer reaction products and extender(s) may occur. Preferably, chemical bonding, which takes place between the polymer and the extender(s) occurs with substituents along the backbone of the polymer rather than with polymer end groups so as to form a cross-linking network between polymer and extender thereby providing a polymer product which is less likely to result in extender loss and/or shrinkage when used in for example a sealant composition. For the sake of clarification with respect to this paragraph the term “chemically bond” is intended to mean the formation of covalent or the like bonds and not mere chemical interactions such as hydrogen bonding or the like.

When the reactable groups in (a) are condensable groups, the composition further comprises a condensation catalyst (d). This increases the speed at which the composition cures. The condensation catalyst (d) chosen for inclusion in a particular silicone sealant composition depends upon the speed of cure required. The amount of catalyst used depends on the cure system being used but typically is from 0.01 to 3% by weight of the total composition Any suitable condensation catalyst (d) may be utilised to cure the composition these include condensation catalysts including tin, lead, antimony, iron, cadmium, barium, manganese, zinc, chromium, cobalt, nickel, aluminium, gallium or germanium and zirconium. Examples include organic tin metal catalysts such as triethyltin tartrate, tin octoate, tin oleate, tin naphthate, butyltintri-2-ethylhexoate, tinbutyrate, carbomethoxyphenyl tin trisuberate, isobutyltintriceroate, and diorganotin salts especially diorganotin dicarboxylate compounds such as dibutyltin dilaurate, dimethyltin dibutyrate, dibutyltin dimethoxide, dibutyltin diacetate, dimethyltin bisneodecanoate Dibutyltin dibenzoate, stannous octoate, dimethyltin dineodeconoate, dibutyltin dioctoate of which dibutyltin dilaurate, dibutyltin diacetate are particularly preferred. Other examples include 2-ethylhexoates of iron, cobalt, manganese, lead and zinc may alternatively be used but titanate and/or zirconate based catalysts are preferred.

Silicone sealant compositions which contain oximosilanes or acetoxysilanes as cross-linkers (b) in condensation cure compositions, generally use a tin catalyst for curing, especially diorganotin dicarboxylate compounds such as dibutyltin dilaurate, dibutyltin diacetate, dimethyltin bisneodecanoate.

For compositions which include alkoxysilane cross linker compounds, the preferred curing catalysts are those where M is titanium or zirconium, i.e. where the catalyst comprises titanate or zirconate compounds. Titanate compounds are particularly preferred. Such titanates may comprise a compound according to the general formula Ti[OR]₄ where each R may be the same or different and represents a monovalent, primary, secondary or tertiary aliphatic hydrocarbon group which may be linear or branched containing from 1 to 10 carbon atoms. Optionally the titanate may contain partially unsaturated groups. However, preferred examples of R include but are not restricted to methyl, ethyl, propyl, isopropyl, butyl, tertiary butyl and a branched secondary alkyl group such as 2,4-dimethyl-3-pentyl. Preferably, when each R is the same, R is an unbranched secondary alkyl groups, branched secondary alkyl group or a tertiary alkyl group, in particular, tertiary butyl such as tetrabutyltitanate, tetraisopropyltitanate.

For the avoidance of doubt an unbranched secondary alkyl group is intended to mean a linear organic chain which does not have a subordinate chain containing one or more carbon atoms, i.e. an isopropyl group, whilst a branched secondary alkyl group has a subordinate chain of one or more carbon atoms such as 2,4-dimethyl-3-pentyl.

Any suitable chelated titanates or zirconates may be utilised. Preferably the chelate group used is a monoketoester such as acetylacetonate and alkylacetoacetonate giving chelated titanates such as, for example diisopropyl bis(acetylacetonyl)titanate, diisopropyl bis(ethylacetoacetonyl)titanate, diisopropoxytitanium Bis(Ethylacetoacetate) and the like. Examples of suitable catalysts are additionally described in EP1254192 and WO200149774 which are incorporated herein by reference.

Preferably the condensation catalyst, component (d), will be present in an amount of from 0.3 to 6 parts by weight per 100 parts by weight of component (a), i.e. from about 0.2 to 2 weight % of the composition component (d) may be present in an amount of greater than 6 parts by weight in cases where chelating agents are used.

When the reactable groups in (a) are unsaturated groups or Si—H groups component (d), will be a hydrosilylation catalyst. When the addition reaction chosen is a hydrosilylation reaction, any suitable hydrosilylation catalyst may be utilised. Such hydrosilylation catalysts are illustrated by any metal-containing catalyst which facilitates the reaction of silicon-bonded hydrogen atoms of the SiH terminated organopolysiloxane with the unsaturated hydrocarbon group on the polyoxyethylene. The metals are illustrated by ruthenium, rhodium, palladium, osmium, iridium, or platinum.

Hydrosilylation catalysts are illustrated by the following; chloroplatinic acid, alcohol modified chloroplatinic acids, olefin complexes of chloroplatinic acid, complexes of chloroplatinic acid and divinyltetramethyldisiloxane, fine platinum particles adsorbed on carbon carriers, platinum supported on metal oxide carriers such as Pt(Al₂O₃), platinum black, platinum acetylacetonate, platinum(divinyltetramethyldisiloxane), platinous halides exemplified by PtCl₂, PtCl₄, Pt(CN)₂, complexes of platinous halides with unsaturated compounds exemplified by ethylene, propylene, and organovinylsiloxanes, styrene hexamethyldiplatinum, Such noble metal catalysts are described in U.S. Pat. No. 3,923,705, incorporated herein by reference to show platinum catalysts. One preferred platinum catalyst is Karstedt's catalyst, which is described in Karstedt's U.S. Pat. Nos. 3,715,334 and 3,814,730, incorporated herein by reference. Karstedt's catalyst is a platinum divinyl tetramethyl disiloxane complex typically containing one weight percent of platinum in a solvent such as toluene. Another preferred platinum catalyst is a reaction product of chloroplatinic acid and an organosilicon compound containing terminal aliphatic unsaturation. It is described in U.S. Pat. No. 3,419,593, incorporated herein by reference. Most preferred as the catalyst is a neutralized complex of platinous chloride and divinyl tetramethyl disiloxane, for example as described in U.S. Pat. No. 5,175,325.

Ruthenium catalysts such as RhCl₃(Bu₂S)₃ and ruthenium carbonyl compounds such as ruthenium 1,1,1-trifluoroacetylacetonate, ruthenium acetylacetonate and triruthinium dodecacarbonyl or a ruthenium 1,3-ketoenolate may alternatively be used.

Other hydrosilylation catalysts suitable for use in the present invention include for example rhodium catalysts such as [Rh(O₂CCH₃)₂]₂, Rh(O₂CCH₃)₃, Rh₂(C₈H₁₅O₂)₄, Rh(C₅H₇O₂)₃, Rh(C₅H₇O₂)(CO)₂, Rh(CO)[Ph₃P](C₅H₇O₂), RhX⁴₃[(R³)₂S]₃, (R²₃P)₂Rh(CO)X⁴, (R²₃P)₂Rh(CO)H, Rh₂X⁴₂Y⁴₄, HₐRh_{b}olefin_{c}Cl_{d}, Rh (O(CO)R³)₃₋ₙ(OH)ₙ where X⁴ is hydrogen, chlorine, bromine or iodine, Y⁴ is an alkyl group, such as methyl or ethyl, CO, C₈H₁₄ or 0.5 C₈H₁₂, R³ is an alkyl radical, cycloalkyl radical or aryl radical and R² is an alkyl radical an aryl radical or an oxygen substituted radical; a is 0 or 1, b is 1 or 2, c is a whole number from 1 to 4 inclusive and d is 2,3 or 4, n is 0 or 1. Any suitable iridium catalysts such as Ir(OOCCH₃)₃, Ir(C₅H₇O₂)₃, [Ir(Z²)(En)₂]₂, or (Ir(Z²)(Dien)]₂, where Z² is chlorine, bromine, iodine, or alkoxy, En is an olefin and Dien is cyclooctadiene may also be used.

The hydrosilylation catalyst may be added to the present composition in an amount equivalent to as little as 0.001 part by weight of elemental platinum group metal, per one million parts (ppm) of the composition. Preferably, the concentration of the hydrosilylation catalyst in the composition is that capable of providing the equivalent of at least 1 part per million of elemental platinum group metal. A catalyst concentration providing the equivalent of about 3-50 parts per million of elemental platinum group metal is generally the amount preferred.

Optionally when component (d) is a hydrosilylation catalyst particularly a platinum based catalyst a suitable hydrosilylation catalyst inhibitor may be required. Any suitable platinum group type inhibitor may be used. One useful type of platinum catalyst inhibitor is described in U.S. Pat. No. 3,445,420, which is hereby incorporated by reference to show certain acetylenic inhibitors and their use. A preferred class of acetylenic inhibitors are the acetylenic alcohols, especially 2-methyl-3-butyn-2-ol and/or 1-ethynyl-2-cyclohexanol which suppress the activity of a platinum-based catalyst at 25° C. A second type of platinum catalyst inhibitor is described in U.S. Pat. No. 3,989,667, which is hereby incorporated by reference to show certain olefinic siloxanes, their preparation and their use as platinum catalyst inhibitors. A third type of platinum catalyst inhibitor includes polymethylvinylcyclosiloxanes having three to six methylvinylsiloxane units per molecule.

Compositions containing these catalysts typically require heating at temperatures of 70° C. or above to cure at a practical rate, particularly if an inhibitor is used. Room temperature cure is typically accomplished with such systems by use of a two-part system in which the cross-linker and inhibitor are in one of the two parts and the platinum is in the other part. The amount of platinum is increased to allow for curing at room temperature. The optimum concentration of platinum catalyst inhibitor is that which will provide the desired storage stability or pot life at ambient temperature without excessively prolonging the time interval required to cure the present compositions at elevated temperatures. This amount will vary widely and will depend upon the particular inhibitor that is used, the nature and concentration of the platinum-containing catalyst (d) and the nature of the cross-linker (b). Inhibitor concentrations as low as one mole of inhibitor per mole of platinum will in some instances yield a desirable level of storage stability and a sufficiently short curing period at temperatures above about 70° C. In other cases, inhibitor concentrations of up to 10, 50, 100, 500 or more moles per mole of platinum may be needed. The optimum concentration for a particular inhibitor in a given composition can be determined by routine experimentation.

Organic peroxides may alternatively be used as catalyst (d) which may be utilised in the absence of a cross-linker, particularly when component (a) comprises trialkylsilyl terminal groups and/or unsaturated groups. Suitable organic peroxides include dialkyl peroxides, diphenyl peroxides, benzoyl peroxide, 1,4-dichlorobenzoyl peroxide, 2,4-dichlorobenzoyl peroxide, di-t-butyl peroxide, dicumyl peroxide, tertiary butyl-perbenzoate, monochlorobenzoyl peroxide, ditertiary-butyl peroxide, 2,5-bis-(tertiarybutyl-peroxy)-2,5-dimethylhexane, tertiary-butyl-trimethyl peroxide, tertiary-butyl-tertiary-butyl-tertiary-triphenyl peroxide, 1,1-bis(t-butylperoxy)-3,3,5-trimethylcyclohexane, and t-butyl perbenzoate. The most suitable peroxide based curing agents are benzoyl peroxide, 2,4-dichlorobenzoyl peroxide, di-t-butyl peroxide, and dicumyl peroxide. Such organic peroxides are used at up to 10 parts per 100 parts of the combination of polymer, filler and optional additives. Preferably between 0.2 and 2 parts of peroxide are used.

Compositions of this invention may contain, as optional constituents, other ingredients which are conventional to the formulation of silicone rubber sealants and the like. For example, the compositions may contain one or more finely divided, reinforcing fillers (e) such as high surface area fumed and precipitated silicas and to a degree calcium carbonate or additional non-reinforcing fillers such as crushed quartz, diatomaceous earths, barium sulphate, iron oxide, titanium dioxide and carbon black, talc, wollastonite. Other fillers which might be used alone or in addition to the above include aluminite, calcium sulphate(anhydrite), gypsum, calcium sulphate, magnesium carbonate, clays such as kaolin, aluminium trihydroxide, magnesium hydroxide(brucite), graphite, copper carbonate, e.g. malachite, nickel carbonate, e.g. zarachite, barium carbonate, e.g. witherite and/or strontium carbonate e.g. strontianite

Aluminium oxide, silicates from the group consisting of olivine group; garnet group; aluminosilicates; ring silicates; chain silicates; and sheet silicates. The olivine group comprises silicate minerals, such as but not limited to, forsterite and Mg₂SiO₄. The garnet group comprises ground silicate minerals, such as but not limited to, pyrope; Mg₃Al₂Si₃O₁₂; grossular; and Ca₂Al₂Si₃O₁₂. Aluninosilicates comprise ground silicate minerals, such as but not limited to, sillimanite; Al₂SiO₅; mullite; 3Al₂O₃.2SiO₂; kyanite; and Al₂SiO₅

The ring silicates group comprises silicate minerals, such as but not limited to, cordierite and Al₃(Mg,Fe)₂[Si₄AlO₁₈]. The chain silicates group comprises ground silicate minerals, such as but not limited to, wollastonite and Ca[SiO₃].

The sheet silicates group comprises silicate minerals, such as but not limited to, mica; K₂Al₁₄[Si₆Al₂O₂₀](OH)₄; pyrophyllite; Al₄[Si₈O₂₀](OH)₄; talc; Mg₆[Si₈O₂₀](OH)₄; serpentine for example, asbestos; Kaolinite; Al₄[Si₄O₁₀](OH)₈; and vermiculite.

In addition, a surface treatment of the filler(s) may be performed, for example with a fatty acid or a fatty acid ester such as a stearate, or with organosilanes, organosiloxanes, or organosilazanes hexaalkyl disilazane or short chain siloxane diols to render the filler(s) hydrophobic and therefore easier to handle and obtain a homogeneous mixture with the other sealant components The surface treatment of the fillers makes the ground silicate minerals easily wetted by the silicone polymer. These surface modified fillers do not clump, and can be homogeneously incorporated into the silicone polymer. This results in improved room temperature mechanical properties of the uncured compositions. Furthermore, the surface treated fillers give a lower conductivity than untreated or raw material.

The proportion of such fillers when employed will depend on the properties desired in the elastomer-forming composition and the cured elastomer. Usually the filler content of the composition will reside within the range from about 5 to about 500 parts by weight per 100 parts by weight of the polymer excluding the extender portion.

The composition in accordance with the present invention provides the user with formulations suitable for applications including, sealants formulations and silicone rubber formulations.

Other ingredients which may be included in the compositions include but are not restricted to co-catalysts for accelerating the cure of the composition such as metal salts of carboxylic acids and amines; rheological modifiers; Adhesion promoters, pigments, Heat stabilizers, Flame retardants, UV stabilizers, Chain extenders, cure modifiers, electrically and/or heat conductive fillers, Fungicides and/or biocides and the like (which may suitably by present in an amount of from 0 to 0.3% by weight), water scavengers, (typically the same compounds as those used as cross-linkers or silazanes). It will be appreciated that some of the additives are included in more than one list of additives. Such additives would then have the ability to function in all the different ways referred to.

The rheological additives include silicone organic co-polymers such as those described in EP 0802233 based on polyols of polyethers or polyesters; non-ionic surfactants selected from the group consisting of polyethylene glycol, polypropylene glycol, ethoxylated castor oil, oleic acid ethoxylate, alkylphenol ethoxylates, copolymers or ethylene oxide (EO) and propylene oxide (PO), and silicone polyether copolymers; as well as silicone glycols. For some systems rheological additives, particularly copolymers of ethylene oxide (EO) and propylene oxide (PO), and silicone polyether copolymers may enhance the adhesion of the sealant to substrates, particularly plastic substrates.

Any suitable adhesion promoter(s) may be incorporated in a sealant composition in accordance with the present invention. These may include for example alkoxy silanes such as aminoalkylalkoxy silanes, epoxyalkylalkoxy silanes, for example, 3-glycidoxypropyltrimethoxysilane and, mercapto-alkylalkoxy silanes and γ-aminopropyl triethoxysilane, reaction products of ethylenediamine with silylacrylates. Isocyanurates containing silicon groups such as 1,3,5-tris(trialkoxysilylalkyl)isocyanurates may additionally be used. Further suitable adhesion promoters are reaction products of epoxyalkylalkoxy silanes such as 3-glycidoxypropyltrimethoxysilane with amino-substituted alkoxysilanes such as 3-aminopropyltrimethoxysilane and optionally alkylalkoxy silanes such as methyl-trimethoxysilane. epoxyalkylalkoxy silane, mercaptoalkylalkoxy silane, and derivatives thereof.

Heat stabilizers may include Iron oxides and carbon blacks, Iron carboxylate salts, cerium hydrate, barium zirconate, cerium and zirconium octoates, and porphyrins.

Flame retardants may include for example, carbon black, hydrated aluminium hydroxide, and silicates such as wollastonite, platinum and platinum compounds.

Chain extenders may include difunctional silanes which extend the length of the polysiloxane polymer chains before cross linking occurs and, thereby, reduce the modulus of elongation of the cured elastomer. Chain extenders and cross linkers compete in their reactions with the functional polymer ends; in order to achieve noticeable chain extension, the difunctional silane must have substantially higher reactivity than the typical trifunctional cross-linker. Suitable chain extenders for condensation cure systems are, for example, Diacetamidosilanes such as dialkyldiacetamidosilanes or alkenylalkyldiacetamidosilanes, particularly methylvinyldi(N-methylacetamido)silane, or dimethyldi(N-methylacetamido)silane diacetoxysilanes, such as dialkyldiacetoxysilanes and alkylalkenyldiacetoxysilanes diaminosilanes, such as dialkyldiaminosilanes or alkylalkenyldiaminosilanes particularly those where each amino group has one Si—N bond and two N—C bonds; dialkoxysilanes such as dimethoxydimethylsilane and diethoxydimethylsilane; a polydialkylsiloxane having a degree of polymerisation of from 2 to 25 and having at least two acetamido or acetoxy or amino or alkoxy or amido or ketoximo substituents per molecule, wherein each alkyl group independently comprises from 1 to 6 carbon atoms;

hexaorganocyclotrisilazanes, octoorganocyclotetrasilazanes, diamidosilanes such as dialkyldiamidosilanes or alkylalkenyldiamidosilanes diketoximinosilanes such as dialkylkdiketoximinosilanes and alkylalkenyldiketoximinosilanes α-aminoalkyldialkoxyalkylsilanes wherein the alkyl and alkoxy groups contain from 1 to 5 carbon atoms, such as α-aminomethyldialkoxymethylsilanes particularly preferred are those where aminomethyl group is an N,N-dialkylaminomethyl group.

Specific examples of chain extenders include alkenyl alkyl dialkoxysilanes such as vinyl methyl dimethoxysilane, vinyl ethyldimethoxysilane, vinyl methyldiethoxysilane, vinylethyldiethoxysilane, alkenylalkyldioximosilanes such as vinyl methyl dioximosilane, vinyl ethyldioximosilane, vinyl methyldioximosilane, vinylethyldioximosilane, alkenylalkyldiacetoxysilanes such as vinyl methyl diacetoxysilane, vinyl ethyldiacetoxysilane, and alkenylalkyldihydroxysilanes such as vinyl methyl dihydroxysilane, vinyl ethyldihydroxysilane, vinyl methyldihydroxysilane, vinylethyldihydroxysilane.methylphenyl-dimethoxysilane, di-butoxy diacetoxysilane, Alkylalkenylbis(N-alkylacetamido)silanes such as methylvinyldi-(N-methylacetamido)silane and methylvinyldi-(N-ethylacetamido)silane; dialkylbis(N-arylacetamido)silanes such as dimethyldi-(N-methylacetamido)silane; and dimethyldi-(N-ethylacetamido)silane; Alkylalkenylbis(N-arylacetamido)silanes such as methylvinyldi(N-phenylacetamido)silane and dialkylbis(N-arylacetamido)silanes such as dimethyldi-(N-phenylacetamido)silane, methylvinyl bis(N-methylacetamido)silane, methylhydrogendiacetoxysilane, dimethylbis(N-diethylaminoxy)silane and dimethylbis(sec.-butylamino)silane. The chain extender used may also comprise any combination of two or more of the above.

Electrically conductive fillers may include carbon black, metal particles such as silver particles any suitable, electrically conductive metal oxide fillers such as titanium oxide powder whose surface has been treated with tin and/or antimony, potassium titanate powder whose surface has been treated with tin and/or antimony, tin oxide whose surface has been treated with antimony, and zinc oxide whose surface has been treated with aluminium.

Thermally conductive fillers may include metal particles such as powders, flakes and colloidal silver, copper, nickel, platinum, gold aluminium and titanium, metal oxides, particularly aluminium oxide (Al₂O₃) and beryllium oxide (BeO);magnesium oxide, zinc oxide, zirconium oxide; Ceramic fillers such as tungsten monocarbide, silicon carbide and aluminium nitride, boron nitride and diamond.

Any suitable Fungicides and biocides may be utilised, these include N-substituted benzimidazole carbamate, benzimidazolylcarbamate such as methyl 2-benzimidazolylcarbamate, ethyl 2-benzimidazolylcarbamate, isopropyl 2-benzimidazolylcarbamate, methyl N-{2-[1-(N,N-dimethylcarbamoyl)benzimidazolyl]}carbamate, methyl N-{2-[1-(N,N-dimethylcarbamoyl)-6-methylbenzimidazolyl]}carbamate, methyl N-{2-[1-(N,N-dimethylcarbamoyl)-5-methylbenzimidazolyl]}carbamate, methyl N-{2-[1-(N-methylcarbamoyl)benzimidazolyl]}carbamate, methyl N-{2-[1-(N-methylcarbamoyl)-6-methylbenzimidazolyl]}carbamate, methyl N-{2-[1-(N-methylcarbamoyl)-5-methylbenzimidazolyl]}carbamate, ethyl N-{2-[1-(N,N-dimethylcarbamoyl)benzimidazolyl]}carbamate, ethyl N-{2-[2-(N-methylcarbamoyl)benzimidazolyl]}carbamate, ethyl N-{2-[1-(N,N-dimethylcarbamoyl)-6-methylbenzimidazolyl]}carbamate, ethyl N-{2-[1-(N-methylcarbamoyl)-6-methylbenzimidazolyl]}carbamate, isopropyl N-{2-[1-(N,N-dimethylcarbamoyl)benzimidazolyl]}carbamate, isopropyl N-{2-[1-(N-methylcarbamoyl)benzimidazolyl]}carbamate, methyl N-{2-[1-(N-propylcarbamoyl)benzimidazolyl]}carbamate, methyl N-{2-[1-(N-butylcarbamoyl)benzimidazolyl]}carbamate, methoxyethyl N-{2-[1-(N-propylcarbamoyl)benzimidazolyl]}carbamate, methoxyethyl N-{2-[1-(N-butylcarbamoyl)benzimidazolyl]}carbamate, ethoxyethyl N-{2-[1-(N-propylcarbamoyl)benzimidazolyl]}carbmate, ethoxyethyl N-{2-[1-(N-butylcarbamoyl)benzimidazolyl]}carbamate, methyl N-{1-(N,N-dimethylcarbamoyloxy)benzimidazolyl]}carbamate, methyl N-{2-[N-methylcarbamoyloxy)benzimidazolyl]}carbamate, methyl N-{2-[1-(N-butylcarbamoyloxy)benzoimidazolyl]}carbamate, ethoxyethyl N-{2-[1-(N-propylcarbamoyl)benzimidazolyl]}carbamate, ethoxyethyl N-{2-[1-(N-butylcarbamoyloxy)benzoimidazolyl]}carbamate, methyl N-{2- [1-(N,N-dimethylcarbamoyl)-6-chlorobenzimidazolyl]}carbamate, and methyl N-{2-[1-(N,N-dimethylcarbamoyl)-6-nitrobenzimidazolyl]}carbamate. 10,10′-oxybisphenoxarsine (trade name: Vinyzene, OBPA), di-iodomethyl-para-tolylsulfone, benzothiophene-2-cyclohexylcarboxamide-S,S-dioxide, N-(fluordichloridemethylthio)phthalimide (trade names: Fluor-Folper, Preventol A3). Methyl-benzimideazol-2-ylcarbamate (trade names: Carbendazim, Preventol BCM), Zinc-bis(2-pyridylthio-1-oxide) (zinc pyrithion) 2-(4-thiazolyl)-benzimidazol, N-phenyl-iodpropargylcarbamate, N-octyl-4-isothiazolin-3-on, 4,5-dichloride-2-n-octyl-4-isothiazolin-3-on, N-butyl-1,2-benzisothiazolin-3-on and/or Triazolyl-compounds, such as tebuconazol in combination with zeolites containing silver.

Condensation cure compositions in accordance with the present invention are preferably room temperature vulcanisable compositions in that they cure at room temperature without heating. Whilst hydrosilylation cured compositions in accordance with the present invention may commence at room temperature heating is preferred.

In the case of condensation cure compositions can be prepared by mixing the ingredients employing any suitable mixing equipment. Other components may be added as necessary. For example preferred one part, moisture curable compositions may be made by preparing polymer (a) in the presence of extender/plasticiser (c) mixing together the resulting extended polysiloxane having hydroxyl or hydrolysable groups and or filler used, and mixing this with a pre-mix of the cross linker and catalyst. UV-stabilisers pigments and other additives may be added to the mixture at any desired stage. Alternatively a one part, moisture curable compositions may be made by blending together the polysiloxane having hydroxyl or hydrolysable groups (a), and extender/plasticiser and any filler used, and mixing this with a pre-mix of the cross linker and catalyst. UV-stabilisers pigments and other additives may be added to the mixture at any desired stage.

After preparation as described above the condensation curable compositions may be stored under substantially anhydrous conditions, for example in sealed containers, until required for use.

Condensation curable compositions according to this aspect of the invention are stable in storage but cure on exposure to atmospheric moisture and may be employed in a variety of applications, for example as coating, caulking and encapsulating materials. They are, however, particularly suitable for sealing joints, cavities and other spaces in articles and structures which are subject to relative movement. They are thus particularly suitable as glazing sealants and for sealing building structures where the visual appearance of the sealant is important.

Thus in a further aspect, the invention provides a method of sealing a space between two units, said method comprising applying a composition as described above and causing or allowing the composition to cure. Suitable units include glazing structures or building units as described above and these form a further aspect of the invention.

Many sealant compositions in accordance with the present invention are often supplied for use in cartridge packs made from a suitable (typically) rigid plastic material such as polyethylene. One advantage of using high molecular weight extenders in accordance with the present invention is that for polyethylene cartridges reduced swelling of the polyethylene used is observed. It was determined by the inventors that the increase in swelling observed with extended sealant formulations in polyethylene cartridges correlated with the molecular weight of the extender in the sealant composition.

Other optional ingredients which may be incorporated in organic peroxide curable and/or hydrosilylation curable silicone rubber compositions in accordance with the present invention of a high consistency silicone rubber include handling agents, peroxide cure co-agents, acid acceptors, and UV stabilisers.

Handling agents are used to modify the uncured properties of the silicone rubber such as green strength or processability sold under a variety of trade names such as SILASTIC® HA-1, HA-2 and HA-3 sold by Dow Corning corporation)

Peroxide cure co-agents are used to modify the properties, such as tensile strength, elongation, hardness, compression set, rebound, adhesion and dynamic flex, of the cured rubber. These may include di- or tri-functional acrylates such as Trimethylolpropane Triacrylate and Ethylene Glycol Dimethacrylate; Triallyl Isocyanurate, Triallyl Cyanurate, Polybutadiene oligomers and the like. Silyl-hydride functional siloxanes may also be used as co-agents to modify the peroxide catalysed cure of siloxane rubbers.

The acid acceptors may include Magnesium oxide, calcium carbonate, Zinc oxide and the like.

The ceramifying agents can also be called ash stabilisers and include silicates such as wollastonite.

The silicone rubber composition in accordance with this embodiment may be made by any suitable route, for example one preferred route is to first make a silicone rubber base by heating a mixture of fumed silica, a treating agent for the silica, and the diluted organopolysiloxane containing polymer of the present invention. The silicone rubber base is removed from the first mixer and transferred to a second mixer where generally about 150 parts by weight of a non-reinforcing or extending filler such as ground quartz is added per 100 parts by weight of the silicone rubber base. Other additives are typically fed to the second mixer such as curing agents, pigments and colouring agents, heat stabilizers, anti-adhesive agents, plasticizers, and adhesion promoters. In a second preferred route the diluted organopolysiloxane containing polymer of the present invention and any desired filler plus any desired treating agent are fed into a reactor and mixed, further additives as described above including cure agents are then fed into the same reactor and further mixed.

In accordance with a further embodiment of the invention there is provided the use of one or more natural oils, and/or derivatives thereof as extenders and/or plasticisers in organosiloxane based compositions, particularly composition for sealant type applications and silicone rubber based applications.

For such use the extender/plasticiser may be introduced into the composition in any suitable manner. Particularly preferred alternatives are by blending with other pre-formed ingredients or by being added to the polymer component prior to or during its manufacture and prior to the introduction of any other ingredients.

The invention will now be described by way of Example.

### EXAMPLES

In the following examples all viscosity measurements relating to organopolysiloxane polymers were taken at 25° C.

### Example 1 Weight Loss

One of the key properties of an organic plasticizer in a silicone composition (such as a rubber or sealant) is the effective weight loss caused by evaporation of the extender. The weight loss is indicative of the extent to which the composition will shrink during use. The weight loss of a biodiesel oil in the form of methyloleate was determined using a drafted oven at 70° C. for several days. The 7 day measurement is related to the ISO10563 standard that drives the requirement for most relevant ISO, DIN and SNJF certification for sealants. The weight loss evolution is shown in Table 1a.

TABLE 1A

| Time (days) | Weight loss (wt %) |
|---|---|
| 0 | 0 |
| 1 | 6 |
| 2 | 6.2 |
| 3 | 6.9 |
| 4 | 7.9 |
| 7 | 10 |
| 8 | 12.7 |
| 9 | 13.8 |
| 14 | 17.9 |
| 15 | 18.8 |
| 16 | 19.7 |

The seven day value was compared with equivalent results from a variety of commercially available, commonly used, mineral oil based extenders in Table 1b.

TABLE 1B

| | Weight loss @ 70° C. |
|---|---|
| | for 7 Days (wt %) |
| TOTAL ® Hydroseal ® G232H | 100 |
| TOTAL ® Hydroseal ® G250H | 83.8 |
| TOTAL ® Hydroseal ® G3H | 60.3 |
| TOTAL ® Hydroseal ® G400H | 21.8 |
| CARLESS ® Pilot 300 | 100 |
| CARLESS ® Pilot 400 | 69.4 |
| CARLESS ® Pilot 600 | 35 |
| CARLESS ® Pilot 900 | 18.1 |
| JANEX ® process oil 2 | 18.8 |
| SHRIEVE ® progiline 109 | 18.6 |
| BIODIESEL Oil | 10 |

The biodiesel extender is clearly seen to be the least volatile when compared with the extenders tested.

### Example 2

### Heat Cured Silicone Rubber

A Winkworth Z-blade mixer was loaded with 1200 g of a 70 durometer polydimethylsiloxane gum composition comprising,
35 parts by weight dimethylvinyl siloxy terminated dimethyl siloxane gum, having a plasticity of from 55 to 65 mils
27 parts by weight dimethylvinyl siloxy terminated dimethyl methylvinyl siloxane gum, having a plasticity of from 55 to 65 mils
1 parts by weight of hydroxy-terminated dimethyl methylvinyl siloxane having a viscosity of 20 mPa·s at 25° C.
5 parts by weight of hydroxy-terminated dimethyl siloxane having a viscosity of about 21 mPa·s at 25° C.
34 parts by weight of fumed silica
   This was allowed to mix on its own for several minutes at ambient temperature. 300 g of a Biodiesel oil (a mixed fatty acid methyl ester derived from Palm and Sunflower Oil) was then added over the course of about 2 hours. This gave a master batch comprising 80% by weight of the 70 durometer polydimethylsiloxane composition and 20% extender (MB1).

Further samples were then prepared, on a two roll mill, at different concentrations of Biodiesel by introducing varying amounts of the 70 durometer polydimethylsiloxane composition described above (Biodiesel free) into MB1. A hydrosilylation curing system was added in the amounts indicated in Table 2a below. Each resulting sample was cured for 10 minutes at 130° C. to give a test sheet which was tested as indicated in Table 2a below

TABLE 2A

| Sample | 2.1 | 2.2 | 2.3 | 2.4 |
|---|---|---|---|---|
| MB1 | 100 | 50 | 25 | 0 |
| 70 duro elastomer parts | 0 | 50 | 75 | 100 |
| Platinum Vinyl siloxane complex masterbatch | 0.9 | 0.9 | 0.9 | 0.9 |
| in siloxane (~0.1% w/w Pt) parts | | | | |
| Poly-dimethyl-methylhydrogen-siloxane | 5 | 5 | 5 | 5 |
| copolymer master batch in siloxane (~0.16% | | | | |
| w/w SiH as H) parts | | | | |
| 1-Ethynyl-1-cyclohexanol master batch in | 2.2 | 2.2 | 2.2 | 2.2 |
| siloxane (10% w/w) parts | | | | |
| Tensile Strength (ISO 37: 1994 Type 2) (MPa) | 8.3 | 8.7 | 9.6 | 9.7 |
| Elongation at Break (ISO 34: 1994 Type 2) (%) | 1166 | 1117 | 974 | 711 |
| Hardness (BS ISO EN 868: 2003) (Durometer | 34.5 | 42.3 | 53.6 | 65.5 |
| Shore A) | | | | |
| Tear Strength (ASTM 624 −98, Die B) (kNm⁻¹) | 52.5 | 54.5 | 57.3 | 50.8 |
| Density (kg/m³) | 1.1286 | 1.1623 | 1.1760 | 1.1970 |

### Comparative Samples

Other than replacing biodiesel oil extender with 300 g of a mineral oil extender (Hydrotreated Middle Distillates (Petroleum-Pilot 900, Petrochem Carless), the same method used in the preparation of Samples 2.1 to 2.4 above was used to prepare the comparative samples C1 to C4 detailed in Table2b below. It was found to be necessary however for the mineral oil extender to be added over the course of several hours (˜6 hrs) as too rapid addition resulted in poor incorporation of the extender and slowed the speed of mixing considerably. This gave a 20% extender master batch (MB2).

TABLE 2B

| Comparative Samples | C1 | C2 | C3 | C4 |
|---|---|---|---|---|
| MB2 parts | 100 | 50 | 25 | 0 |
| 70 duro elastomer parts | 0 | 50 | 75 | 100 |
| Platinum Vinyl siloxane complex masterbatch | 0.9 | 0.9 | 0.9 | 0.9 |
| in siloxane (~0.1% w/w Pt) parts | | | | |
| Poly-dimethyl-methylhydrogen-siloxane | 5 | 5 | 5 | 5 |
| copolymer master batch in siloxane (~0.16% | | | | |
| w/w SiH as H) parts | | | | |
| 1-Ethynyl-1-cyclohexanol master batch in | 2.2 | 2.2 | 2.2 | 2.2 |
| siloxane (10% w/w) parts | | | | |
| Tensile Strength (ISO 37: 1994 Type 2) (Mpa) | 7.7 | 8.8 | 9.3 | 9.7 |
| Elongation at Break (ISO 34: 1994 Type 2) (%) | 858 | 765 | 747 | 711 |
| Hardness (BS ISO EN 868: 2003) (Durometer | 38.3 | 52.1 | 57.8 | 65.5 |
| Shore A) | | | | |
| Tear Strength (ASTM 624 −98, Die B) (kNm⁻¹) | 55.8 | 53.9 | 52.0 | 50.8 |
| Density (kg/m³) | 1.1035 | 1.1470 | 1.1704 | 1.1970 |

The results show that the mineral oil hydrocarbon extender in comparative examples C1-C4 can be readily replaced with a bio-renewable extender with little change in product performance. Use of mixed fatty acid methyl esters as an extender gives enhancements in elongation at break.

### Example 3

### Moisture Cured Acetoxy Sealant Formulation

Sealant compositions were compounded in a HAUSCHILD dental mixer and characterized for both uncured and cured sealant properties. Table 3a shows the formulations explored, and the results of the compositions tested are disclosed in Table3b.

TABLE 3A

| | 3.1 | 3.2 |
|---|---|---|
| Ingredient | Wt % | Wt % |
| Hydroxydimethylsilyl terminated | 77.985 | 82.985 |
| dimethylpolysiloxane 80 000 mPa · s at 25° C. | | |
| Biodiesel (methyl oleate) | 10.0 | 5.0 |
| Methyltriacetoxysilane | 2.0 | 2.0 |
| Ethyltriacetoxysilane | 2.0 | 2.0 |
| Fumed silica | 8. | 8.0 |
| Dibutyl tin diacetate | 0.015 | 0.015 |
| Total | 100.0 | 100.0 |

TABLE 3B

| Test | 2 | 3 |
|---|---|---|
| Specific Gravity (ASTM D1475-98) (kg/l) | 1.01 | 1.01 |
| Penetration (mm × 10³) | 147 | 129 |
| Cure in Depth (mm/24 hours) | 4.4 | 4.7 |
| Skin over Time (min) | 15 | 13 |
| Tack over Time (ASTM D2377-94) (min) | 13 | 11 |
| Tensile Strength (ASTM D412-98a) (Mpa) | 1.32 | 1.31 |
| (2 mm sheet) | | |
| Elongation at Break (ASTM D412-98a) (%) | 373 | 443 |
| 100% Modulus (ASTM D638-97) (Mpa) | 0.49 | 0.40 |
| Hardness (ASTM D2240-97) (Shore A) | 26 | 21 |

The cure in depth tests were undertaken to determine how far below the surface the sealant had hardened in 24 hours by filling a suitable container (avoiding the introduction of air pockets) with sealant, curing the sealant contained in the container for the appropriate period of time at room temperature (about 23° C.) and about 50% relative humidity. After the appropriate curing time the sample is removed from the container and the height of the cured sample is measured.

### Example 4

Moisture Cured Alkoxy sealant formulation and test results. Silanol terminated silicone oligomer 50,000 mPa·s at 25° C. was compounded with a biodiesel extender and the other ingredients in the composition in a HAUSCHILD dental mixer and characterized for both uncured and cured sealant properties. Starting from a reference chalk alkoxy formulation, the Trimethyl terminated silicone polymer 100 mPa·s at 25° C. plasticizer was replaced with biodiesel oil as can be seen in Table 4a.

TABLE 4A

| | | Comparative |
|---|---|---|
| | Example | example - chalk |
| | biodiesel | alkoxy |
| Ingredients | (wt %) | (wt %) |
| Silanol terminated silicone oligomer | 30.22 | 30.25 |
| 50,000 mPa · s at 25° C. | | |
| Biodiesel Oil | 12.63 | 0.00 |
| Trimethyl terminated silicone polymer | 0.00 | 12.63 |
| 100 mPa · s at 25° C. | | |
| CaCO₃ precipitated (Socal 312) | 31.15 | 31.15 |
| CaCO₃ ground (Mikart) | 23.15 | 23.15 |
| Methyltrimethoxysilane | 2.12 | 2.12 |
| Diisopropoxytitanium | 0.72 | 0.72 |
| bis(ethylacetoacetate) | | |

TABLE 4B

| | | Comparative |
|---|---|---|
| | Example | example chalk |
| | biodiesel | alkoxy |
| Standards properties | | |
| Specific Gravity (ASTM D1475-98) (kg/l) | 1.41 | 1.52 |
| Penetration (mm × 10³) | 159 | 120 |
| Cure in Depth (mm/24 hours) | 1.1 | 2.3 |
| Skin over Time (min) | 33 | 16 |
| Tack over Time (ASTM D2377-94) (min) | 37 | 35 |
| Mechanical properties sheet | | |
| Tensile Strength (ASTM D412-98a) | 2.70 | 1.90 |
| (Mpa) (2 mm sheet) | | |
| Elongation at Break (ASTM D412-98a) (%) | 697 | 688 |
| 100% Modulus (ASTM D638-97) (Mpa) | 0.15 | 0.45 |
| Hardness (ASTM D2240-97) (Shore A) | 14 | 30 |

The cure in depth test was carried out as described under Example 3. In comparison with the reference chalk alkoxy formulation, the alkoxy sealant containing biodiesel showed a lower specific gravity as well as a lower modulus.

1. An organopolysiloxane composition capable of cure to an elastomeric body, the composition comprising:
a) an organopolysiloxane containing polymer having not less than two reactable silicon-bonded groups selected from alkenyl groups, condensable groups, silyl-hydride groups and/or one or more trialkylsilyl containing terminal groups;
b) if required, a siloxane and/or silane cross-linker having at least two groups per molecule which are reactable with the reactable groups in a);
c) 5 to 50% by weight of the composition of at least one compatible natural oil and/or natural oil derivative based extender and/or plasticizer;
d) a suitable cure catalyst; and optionally
e) one or more fillers.

2. A composition in accordance with claim 1 characterised in that c) is selected from one or more of the following almond oil, avocado oil, beef tallow, borrage oil, butterfat, canola oil, cardanol, cashew nut oil, cashew nutshell liquid, castor oil, citrus seed oil, cocoa butter, coconut oil, cod liver oil, corn oil, cottonseed oil, cuphea oil, evening primrose oil, hemp oil, jojoba oil, lard, linseed oil, macadamia oil, menhaden oil, oat oil, olive oil, palm kernel oil, palm oil, peanut oil, poppy seed oil, rapeseed oil, rice bran oil, safflower oil, safflower oil (high oleic), sesame oil, soybean oil, sunflower oil, sunflower oil (high oleic), tall oil, tea tree oil, turkey red oil, walnut oil, perilla oil, dehydrated castor oils, apricot oil, pine nut oil, kukui nut oil, amazon nut oil, almond oil, babasu oil, argan oil, black cumin oil, bearberry oil, calophyllum oil, camelina oil, carrot oil, carthamus oil, cucurbita oil, daisy oil, grape seed oil, foraha oil, queensland oil, onoethera oil, ricinus oil, tamanu oil, tucuma oil, and fish oils.

3. A composition in accordance with claim 1 characterised in that c) is selected from one or more of the following a blown natural oil, a stand natural oil, a boiled natural oil, and a transesterified natural oil derivative.

4. A composition in accordance with claim 3 characterised in that c) is a biodiesel oil.

5. A composition in accordance with claim 1 characterised in that a) has not less than two reactable silicon-bonded, condensable groups.

6. A composition in accordance with claim 5 characterised in that b) is selected from one or more of the following alkyltrialkoxysilanes, alkenyltrialkoxy silanes, alkenyl alkyl dialkoxysilanes, and alkenyl alkyl dialkoxysilanes.

7. A composition in accordance with claim 5 characterised in that d) is selected from one or more of the following titanate, a zirconate, a chelated titanate, a chelated zirconate, and an organotin compound.

8. A composition in accordance with claim 1 characterised in that a) has not less than two reactable silicon-bonded, unsaturated groups selected from one or more of the following alkenyl groups, alkynyl groups, acrylate groups, and alkylacrylate groups.

9. A composition in accordance with claim 8 characterised in that b) is an organohydrogensiloxane having an average of greater than two silicon bonded hydrogen atoms per molecule and a viscosity of up to about 10 Pa·s at 25° C.

10. A composition in accordance with claim 8 characterised in that d) is a hydrosilylation catalyst selected from one or more of the following platinum based, rhodium based, iridium based, palladium based, and ruthenium based catalysts.

11. A composition in accordance with claim 1 comprising a filler selected from one or more of the following high surface area fumed and precipitated silicas, calcium carbonate, crushed quartz, diatomaceous earths, barium sulphate, iron oxide, titanium dioxide and carbon black, talc, wollastonite, pyrophyllite, aluminite, calcium sulphate (anhydrite), gypsum, calcium sulphate, magnesium carbonate, clays, aluminium trihydroxide, magnesium hydroxide (brucite), graphite, copper carbonate, nickel carbonate, barium carbonate, and strontium carbonate.

12. A composition in accordance with claim 1 which additionally comprises one or more of the following additives: rheological modifiers, adhesion promoters, pigments, heat stabilizers, flame retardants, UV stabilizers, chain extenders, electrically and/or heat conductive fillers, fungicides, and biocides

13. A method of sealing a space between two units, said method comprising applying a composition according to claim 5 to the space, and causing or allowing the composition to cure.

14. A natural oil and/or natural oil derivative based extender and/or plasticiser in an organopolysiloxane composition.

15. A natural oil and/or natural oil derivative based extender and/or plasticizer in an organopolysiloxane composition in accordance with claim 14 characterised in that the natural oil and/or natural oil derivative based extender and/or plasticizer is selected from one or more of the following almond oil, avocado oil, beef tallow, borrage oil, butterfat, canola oil, cardanol, cashew nut oil, cashew nutshell liquid, castor oil, citrus seed oil, cocoa butter, coconut oil, cod liver oil, corn oil, cottonseed oil, cuphea oil, evening primrose oil, hemp oil, jojoba oil, lard, linseed oil, macadamia oil, menhaden oil, oat oil, olive oil, palm kernel oil, palm oil peanut oil, poppy seed oil, rapeseed oil, rice bran oil, safflower oil, safflower oil (high oleic), sesame oil, soybean oil, sunflower oil, sunflower oil (high oleic), tall oil, tea tree oil, turkey red oil, walnut oil, perilla oil, dehydrated castor oils, apricot oil, pine nut oil, kukui nut oil, amazon nut oil, almond oil, babasu oil, argan oil, black cumin oil, bearberry oil, calophyllum oil, camelina oil, carrot oil, carthamus oil, cucurbita oil, daisy oil, grape seed oil, foraha oil, queensland oil, onoethera oil, ricinus oil, tamanu oil, tucuma oil, and fish oils.

16. A natural oil and/or natural oil derivative based extender and/or plasticizer in an organopolysiloxane composition in accordance with claim 14 characterised in that that the natural oil and/or natural oil derivative based extender and/or plasticiser is selected from one or more of the following a blown natural oil, a stand natural oil, a boiled natural oil, and a transesterified natural oil derivative.

17. A sealant composition comprising the organopolysiloxane composition in accordance with claim 1.

18. A silicone rubber composition comprising the organopolysiloxane composition in accordance with claim 1.

19. A glazing structure or building unit which includes a sealant derived from the organopolysiloxane composition according to claim 1.

20. A multi-pack sealant composition comprising the organopolysiloxane of claim 1 in a first pack comprising the polymer a) and, optionally, one or more fillers e), and a second pack comprising the catalyst d) and the cross-linker b), and wherein optional additives are in either or both of the first and second packs.

21. A composition in accordance with claim 1 characterised in that d) is an organic peroxide.
